(19) United States
(12) Patent Application Publication
(10) Pub. No.: US 2008/0083595 A1
(43) Pub. Date: Apr. 10, 2008

(54) Multi-tooth pawl type gearing mechanism

(76) Inventors: Clinton J. Spiegel, Asheville, NC (US); John Kiffmeyer, Big Lake, MN (US)

Correspondence Address: WELSH & FLAXMAN LLC, 2000 DUKE STREET, SUITE 100, ALEXANDRIA, VA, 22314, US

(21) Appl. No.: 11/802,088

(22) Filed: May 18, 2007

Related U.S. Application Data
(60) Provisional application No. 60/801,383, filed on May 19, 2006.

(51) Int. Cl. F16D 13/04

(52) U.S. Cl. 192/43.1

(57) ABSTRACT

A multi-tooth pawl type gearing mechanism for a freewheel of a bicycle wheel hub includes a cassette body having an inner rotor member with an axis. A gear ring shaped and dimensioned for attachment to a wheel hub of a bicycle wheel is also provided allowing for the transferring of power from the gear ring to the bicycle wheel. The gear ring surrounds the inner rotor member and includes an inner surface. A series of pawls, wherein each pawl includes a first end and a second end, are positioned between the inner rotor member and the gear ring for transmitting power therebetween in a unilateral direction as the inner rotor member is rotated. When the inner rotor member is rotated in a first direction the pawls are brought into engagement with the inner surface of the gear ring thereby transmitting rotation of the inner rotor member to the gear ring and when the inner rotor member is rotated in an opposite second direction the pawls slide over the inner surface of the gear ring and rotation of the inner rotor member is not transmitted to the gear ring.

### CROSS REFERENCE TO RELATED APPLICATION

This application claims the benefit of U.S. Provisional Application Ser. No. 60/801,383, entitled “MULTI-TOOTH PAWL TYPE GEARING MECHANISM”, filed May 19, 2006.

### BACKGROUND OF THE INVENTION

1. Field of the Invention

The invention relates to a freewheel mechanism for a bicycle wheel hub. More particularly, the invention relates to a freewheel mechanism including a multi-tooth pawl assembly.

2. Description of the Prior Art

Many mechanisms for transferring human power into motion on a wheeled type vehicle, for example, a bicycle, have been developed. As those skilled in the art will certainly appreciate, the transfer of human power to a bicycle has commonly been accomplished through leg motion. Most often, the leg motion is transferred to the bicycle through a mechanism employing some sort of chain connected to, and driving, a bicycle wheel.

There has always been a need for a mechanism which engages in one direction and which freely rotates in the other direction, allowing the rider to stop the pedaling motion when necessary. While this has been accomplished through a number of different mechanisms, the most common mechanism currently employed is a pawl type mechanism employed in many freewheel mechanisms found in a bicycle wheel hub.

Pawl type mechanisms utilize a pawl that engages a ring of teeth when one pushes on the pedals of the bicycle in an effort to transfer leg motion to the wheels of the bicycle. The pawls are allowed to engage and ratchet against the gear ring as the ring goes around them. This mechanism has worked well but has several drawbacks.

The primary drawback relates to the engagement time. In particular, engagement time is limited by the number of teeth on the gear ring. Thus, the engagement time is defined as a measurement of the time taken for the pawls to come into interaction with the gear ring and begin driving the apparatus. For example, a twenty-tooth gear ring would have an 18-degree engagement time, or have twenty positions available in a 360-degree rotation, each one equaling 18 degrees between them.

Attempts have been made to increase the speed at which the pawls engage the gear ring. However, these attempts have been met with only limited success. As such, a need exists for an improved mechanism.

### SUMMARY OF THE INVENTION

It is, therefore, an object of the present invention to provide a multi-tooth pawl type gearing mechanism for a freewheel of a bicycle wheel hub. The gearing mechanism includes a cassette body having an inner rotor member with an axis. A gear ring shaped and dimensioned for attachment to a wheel hub of a bicycle wheel is also provided allowing for the transferring of power from the gear ring to the bicycle wheel. The gear ring surrounds the inner rotor member and includes an inner surface. A series of pawls, wherein each pawl includes a first end and a second end, is positioned between the inner rotor member and the gear ring for transmitting power therebetween in a unilateral direction as the inner rotor member is rotated. When the inner rotor member is rotated in a first direction the pawls are brought into engagement with the inner surface of the gear ring thereby transmitting rotation of the inner rotor member to the gear ring and when the inner rotor member is rotated in an opposite second direction the pawls slide over the inner surface of the gear ring and rotation of the inner rotor member is not transmitted to the gear ring.

It is also an object of the present invention to provide a gearing mechanism wherein the pawls are out of phase.

It is another object of the present invention to provide a gearing mechanism wherein each pawl includes a series of teeth along the second end thereof. The teeth are shaped and dimensioned for positioning within recesses formed along the inner surface of the gear ring. The teeth are shaped and dimensioned to seat within the recesses and couple thereto when the inner rotor member is rotated in the first direction and slide over the recesses of the gear ring when the inner rotor member is rotated in the second direction.

It is a further object of the present invention to provide a gearing mechanism wherein the geometry of the teeth on the pawl is designed so that when in free rotation only a tooth furthest from a tip of the pawl and closest to a point of rotation for the pawl interacts with the gear ring to reduce wear on the rest of the teeth.

It is also another object of the present invention to provide a gearing mechanism wherein six pawls are provided.

It is also a further object of the present invention to provide a gearing mechanism wherein a leading edge of the gear ring is angled in a manner facilitating placement of the cassette body and pawls into the gear ring.

It is still a further object of the present invention to provide a gearing mechanism wherein a seal is further provided between the gear ring and the cassette body.

It is yet a further object of the present invention to provide a gearing mechanism wherein a spring is associated with each pawl, and the spring holds the pawl in place and biases respective pawls into the gear ring.

It is also an object of the present invention to provide a gearing mechanism wherein each pawl includes milled portions, the spring engaging an upper surface of the milled portions and acting to rotate the pawl and hold it down into a rotor member recess of the inner rotor member of the cassette body at a particular angle to facilitate ease of placement into recesses formed along the inner surface of the gear ring.

It is still another object of the present invention to provide a gearing mechanism wherein the milled portions on each pawl are shaped and dimensioned to maintain the pawl in a particular position and angle, and keep it from biasing too far toward the gear ring to facilitate an easier placement of the cassette body and pawls into the inner surface of the gear ring where the pawls are pushed down for assembly.

It is also an object of the present invention to provide a gearing mechanism wherein each spring respectively biases the pawl toward the gear ring.

It is another object of the present invention to provide a gearing mechanism wherein each spring is substantially U-shaped.

It is a further object of the present invention to provide a gearing mechanism wherein each spring includes opposed arms which engage opposite sides of the pawl for biasing it toward the gear ring and centering the pawl in the cassette body while the spring action holds the pawl in place.

It is also an object of the present invention to provide a gearing mechanism wherein the inner rotor member includes an outer surface having a series of rotor member recesses shaped and dimensioned for receiving the first end of respective pawls in a manner supporting the pawls for rotation relative thereto.

It is a further object of the present invention to provide a gearing mechanism wherein each of the rotor member recesses includes a semi-circular profile in which the first end of the respective pawl is seated for rotation relative thereto, and each rotor member recess is shaped and dimensioned with a radius of curvature matching the radius of curvature formed along the first end of the pawl.

It is also another object of the present invention to provide a gearing mechanism wherein springs are positioned between each of the pawls and the inner rotor member in a manner which maintains the first end of the pawl within the rotor member recess and biases the second end of the pawl toward the gear ring.

It is also an object of the present invention to provide a gearing mechanism wherein the inner surface of the gear ring is formed with a series of recesses thereabout. The recesses are equally spaced and are shaped and dimensioned for receipt of the respective pawls. The recesses are shaped and dimensioned to engage the second end of the respective pawls when the inner rotor member is rotated in the first direction and permit the second end of the pawls to slide there across when the inner rotor member is rotated in an opposite, second direction.

It is also an object of the present invention to provide a gearing mechanism wherein each recess includes an angularly oriented long first wall and a short second wall, the second wall being oriented such that teeth on the second end of the pawl seat within the recesses and abut the second wall in a manner preventing further rotation of the gear ring relative to the pawl when the inner rotor member is rotated in the first direction, and this configuration allows the teeth of the pawl to slide up and over the long first wall of each recess when the gear ring is rotated in the second direction opposite the first direction.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a perspective view of the gearing mechanism in accordance with the present invention secured to a bicycle wheel.

FIG. 2 is a longitudinal cross sectional view of the present gearing mechanism secured to a wheel hub.

FIG. 3 is a cross sectional view along the line III-III in FIG. 2 with the wheel hub and axle removed.

FIG. 4 is a plan side view of the gearing mechanism.

FIG. 5 is a perspective view of the gearing mechanism.

FIGS. 6 and 7 are respectively a rear plan view and a side plan view of the gear ring.

FIGS. 8, 9 and 10 are respectively a rear plan view, a side plan view and a perspective view of a pawl.

FIGS. 11, 12 and 13 are respectively a rear plan view, a side plan view and a perspective view of a seal, or grease trap, in accordance with a preferred embodiment shown.

FIG. 14 is a perspective view of the cassette body showing the spring used in actuating the pawls.

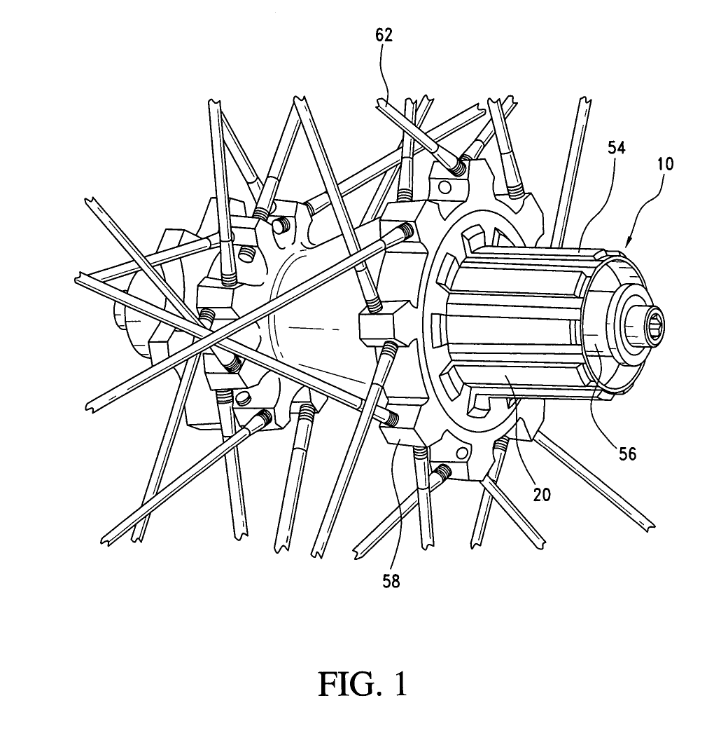

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as the basis for teaching one skilled in the art how to make and/or use the invention.

Referring to the various figures, a multi-tooth pawl type gearing mechanism 10 for a freewheel of a bicycle wheel hub 58 is disclosed. As with traditional freewheel construction, the present gearing mechanism 10 includes an inner rotor member 12 having an axis. The inner rotor member 12 forms part of a cassette body 20 upon which the sprockets 60 and drive chain (not shown) are mounted for the transfer of power thereto during pedaling in a manner well known to those skilled in the art. The inner rotor member 12 is surrounded by a gear ring 14 having an external circumference surface and a wall portion projecting radially outward therefrom. The gear ring 14 includes external threads 52 shaped and dimensioned for attachment to the wheel hub 58 of a bicycle wheel 62 allowing for the transferring of power from the gear ring 14 to the bicycle wheel 62. Although threading is disclosed in accordance with a preferred embodiment, the gear ring could be secured to the wheel hub in a variety of ways, for example, through the use of splines, without departing from the spirit of the present invention.

As those skilled in the art will certainly appreciate, the specific sprocket construction and arrangement used in accordance with the present invention may be varied without departing from the spirit of the present invention. In addition, a variety of drive trains may also be employed without departing from the spirit of the present invention.

A series (that is, a plurality) of pawls 16 is positioned between the inner rotor member 12 and the gear ring 14 for transmitting power therebetween. As will be discussed below in greater detail, the positioning of the pawls 16 between the inner rotor member 12 and the gear ring 14 allows for the transmission of power in a manner such that power is transmitted in a unilateral direction as the inner rotor member 12 is rotated under the control of the sprockets 60 and the drive chain (not shown).

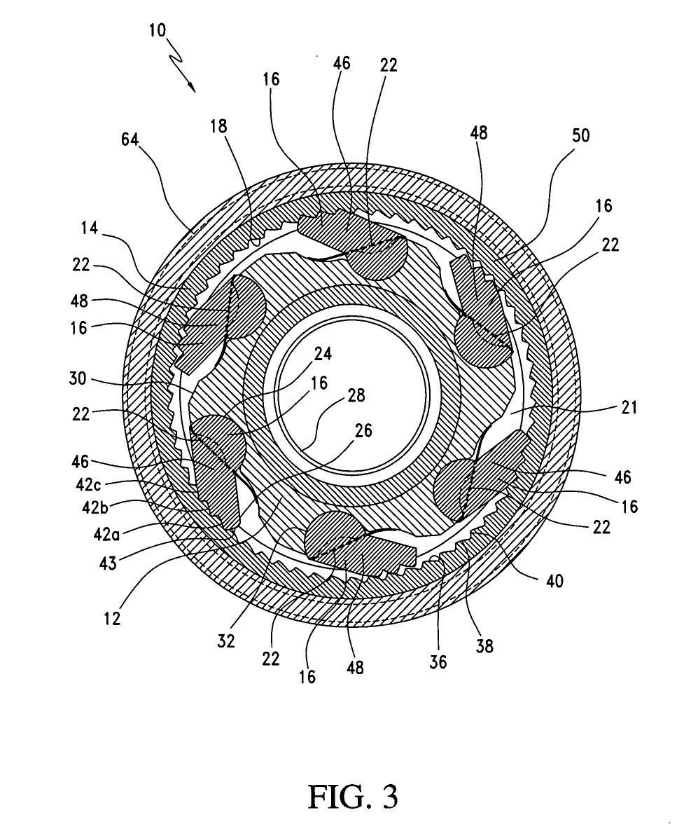

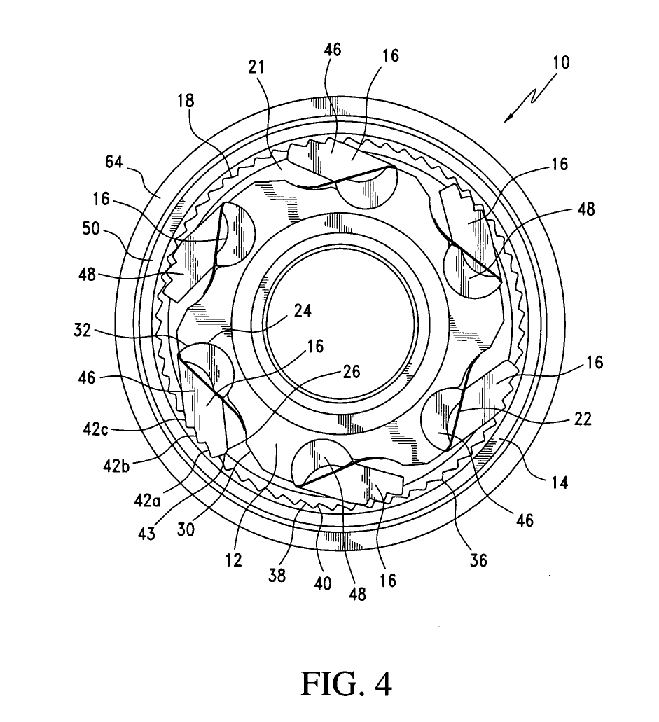

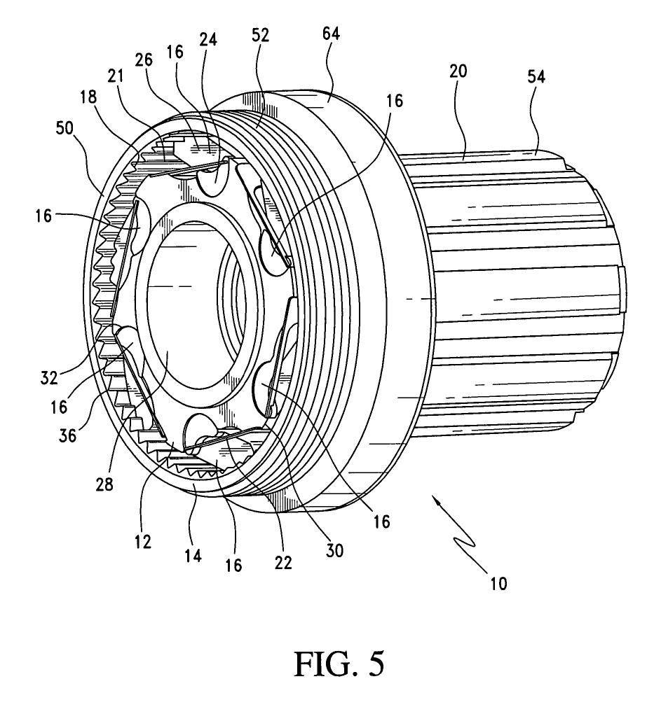

In practice, and with reference to FIGS. 3, 4 and 5, those skilled in the art will certainly appreciate that when the inner rotor member 12 is rotated in a first direction, for example, the counterclockwise direction, the pawls 16 are brought into engagement with the inner surface 18 of the gear ring 14 thereby transmitting the rotation of the inner rotor member 12 to the gear ring 14 (and ultimately to the wheel hub 58), whereas when the inner rotor member 12 is rotated in the opposite direction, for example, the clockwise direction, the pawls 16 slide over the inner surface 18 of the gear ring 14 and clockwise rotation of the inner rotor member 12 is not transmitted to the gear ring 14.

In accordance with a preferred embodiment, rotation of the inner rotor member 12 is transmitted when a drive chain mounted on a front gear fixed on a bicycle crank is rotated by pedaling to apply rotational energy to one of the sprockets 60 secured to the cassette body 20, and ultimately, the inner rotor member 12. As those skilled in the art will certainly appreciate, the application of force to the inner rotor member 12 may be varied by coupling the drive chain to various sprockets 60 depending upon the needs of the specific riding conditions. Conventional well known gear shift devices are employed to achieve switching between various sprockets 60 and fall within the spirit of the present invention.

When a pedal of a bicycle (not shown) is moved in the first direction driving the drive chain and the sprockets 60 in the same direction, the inner rotor member 12 is also moved in the same direction by the selective engagement of one of the sprockets 60 with the driving chain. On the other hand, when the pedal is moved in the opposite second direction driving the drive chain and the sprockets 60 in the same direction, the inner rotor member 12 is also moved in the same direction through the above-mentioned mechanism.

As mentioned above, when the pedal is moved in the first direction, for example, counterclockwise direction, the rotation thereof is transmitted through the inner rotor member 12 to the gear ring 14. However, when it is moved in the opposite second direction, for example, clockwise direction, the rotation thereof is transmitted to the inner rotor member 12 only. In this case, the gear ring 14 is not subject to the rotation of the pedal.

As those skilled in the art will certainly appreciate, the terms clockwise and counterclockwise are relative terms. As such, the concepts underlying the present invention may be applied regardless of the specific relative directions in which the various elements are moved without departing from the spirit of the present invention.

More particularly, and in accordance with a preferred embodiment of the present invention, the inner rotor member 12 forms part of the cassette body 20 that supports the sprockets 60, the chain drive, and the pawls 16 which drive the gear ring 14. In practice, the sprockets 60 and chain are directly linked to the cassette body 20, which is in turn directly linked to the inner rotor member 12. The cassette body 20 includes an attachment structure, for example, splines 54, which allows for the selective attachment of sprockets 60 thereto. Rotation of the inner rotor member 12 in a first direction, for example, counterclockwise, results in the transfer of power between the inner rotor member 12 and the gear ring 14 via the interaction of the pawls 16 and the respective inner rotor member 12 and gear ring 14. Rotation of the inner rotor member 12 in a second direction, for example, clockwise, opposite the first direction results in free rotation of the inner rotor member 12 relative the gear ring 14 as the pawls 16 fail to engage the gear ring 14 in a manner facilitating the transfer of energy therebetween.

More particularly, a plurality of pawls 16 are mounted within the pocket 21 of the cassette body 20 and are positioned between the inner rotor member 12 and the gear ring 14. Each pawl 16 is associated with a spring 22 which holds the pawl 16 in place and biases the respective pawls 16 into the gear ring 14. As best shown with reference to FIG. 14, each spring 22 is substantially U-shaped and includes opposed arms 22a, 22b which engage opposite sides of the pawl 16 for biasing it toward the gear ring 14. Each pawl 16, therefore, includes a first end 24 and a second end 26, the first end 24 being positioned adjacent to and secured to the inner rotor member 12 and the second end 26 being positioned adjacent the gear ring 14 for selective engagement therewith.

The inner rotor member 12 includes an inner surface 28 shaped and dimensioned for rotation about an axle 56 extending through the wheel hub 58. Positioned between the inner rotor member 12 and axle 56 are a series of bearings 59 allowing the inner rotor member 12 to freely rotate about the axle 56 when driven by the sprockets 60.

The outer surface 30 of the inner rotor member 12 includes a series (that is, plurality) of rotor member recesses 32 shaped and dimensioned for receiving representative first ends 24 of the pawls 16 in a manner supporting the respective pawls 16 for rotation relative thereto. With this in mind, each of the rotor member recesses 32 includes a semi-circular profile in which the first end 24 of the pawl 16 is seated for rotation relative thereto. In accordance with a preferred embodiment, each rotor member recess 32 is shaped and dimensioned with a radius of curvature matching the radius of curvature formed along the first end 24 of the pawl 16.

As briefly mentioned above, springs 22 are positioned between each of the pawls 16 and the inner rotor member 12 in a manner which maintains the first end 24 of the pawl 16 within the rotor member recess 32 and biases the second end 26 of the pawl 16 toward the gear ring 14, that is, biases the pawl 16 rotationally in a clockwise direction as shown in FIGS. 3, 4, 5 and 14. The springs 22 bias the first ends 24 of the respective pawls 16 in a manner rotating the representative pawls 16 in a clockwise direction with the second ends 26 of the pawls 16 biased toward the gear ring 14.

The gear ring 14 is retained upon the cassette body 20 in a manner minimizing friction therebetween. The pawls 16 are placed on the cassette body 20 at an angle that allows for the lowest friction while still maintaining the proper angle for engagement of the pawls 16 with the gear ring 14. The pawls 16 sit and are held in place on the inside portion of the present gearing mechanism 10 through the springs 22 which act to hold the pawls 16 in position and keep them biased toward the gear ring 14.

With this in mind, the inner surface 18 of the gear ring 14 is formed with a series (that is, a plurality) of recesses 36 about the entire inner circumference. The recesses 36 are equally spaced and are shaped and dimensioned for receipt of the pawls 16. More particularly, the recesses 36 are shaped and dimensioned to engage the second end 26 of the pawls 16 when the inner rotor member 12 is rotated in a first direction and permit the second end 26 of the pawls 16 to slide there across when the inner rotor member 12 is rotated in an opposite, second direction. As those skilled in the art will appreciate, this is achieved because each recess 36 includes an angularly oriented long first wall 38 and a short second wall 40. The second wall 40 is oriented such that teeth 42a-c on the second end 26 of the pawl 16 seat within the recesses 36 and abut the second wall 40 in a manner preventing further rotation of the gear ring 14 relative to the pawl 16 when the inner rotor member 12 is rotated in a first direction. Similarly, this configuration allows the teeth 42a-c of the pawl 16 to slide up and over the long first wall 38 of each recess 36 when the gear ring 14 is rotated in a second direction opposite the first direction.

The pawls 16 themselves have several features. As briefly discussed above, each pawl 16 includes a first end 24 and a second end 26. The first end 24 is held adjacent the inner rotor member 12 and pivots within the rotor member recess 32 relative thereto as it engages or rides over the inner surface 18 of the gear ring 14. Although only one pawl 16 is discussed herein, those skilled in the art will appreciate that the discussion herein applies equally to all of the pawls employed in conjunction with the mechanism of the present invention.

The pawl 16 includes opposed milled portions 44 at a particular spot so that the opposed arms, or forks, 22a, 22b of the spring 22 respectively engage upper surfaces 44a of the milled portions 44 and act to rotate the pawl 16, and yet hold it down into the pocket 21, more particularly, the rotor member recesses 32 of the inner rotor member 12, of the cassette body 20 at a particular angle to facilitate ease of placement into the recesses 36 formed along the inner surface 18 of the gear ring 14. Referring to FIG. 6, the springs 22 and how the milled portions 44 work in conjunction with the springs 22 is shown. Specifically, the milled portions 44 on the pawl 16 have two features. The milled portions 44 are shaped and dimensioned to maintain the pawl 16 in a particular position and angle, and keep it from biasing too far toward the gear ring 14. This facilitates an easier placement of the cassette body 20 and pawls 16 into the inner surface 18 of the gear ring 14 where the pawls 16 are pushed down for assembly while it is in the wheel hub 58. The milled portions 44 are also shaped and dimensioned to interact with the spring 22 in a manner keeping the pawl 16 biased toward the gear ring 14. The U-shaped spring 22 keeps the pawl 16 in place with the opposed arms, or forks, 22a, 22b on either side of the pawl 16 keeping it centered in the pocket 21 of the cassette body 20 while the spring 16 action holds the pawl 16 in place.

As briefly mentioned above, the pawl 16 includes a series of teeth 42a-c along the second end 26 thereof. In accordance with a preferred embodiment, a first tooth 42a, a second tooth 42b and a third tooth 42c are provided. The teeth 42a-c are shaped and dimensioned for positioning within the recesses 36 formed along the inner surface 18 of the gear ring 14. More particularly, the teeth 42a-c are shaped and dimensioned to seat with the recesses 36 and couple thereto when the inner rotor member 12 is rotated in a first direction and slide over the recesses 36 of the gear ring 14 when the inner rotor member 12 is rotated in a second direction.

The geometry of the teeth 42a-c on the pawl 16 is designed so that when in free rotation that is, rotating in the second direction, the only tooth 42c interacting with the gear ring 14 is the one furthest from the tip 43 (that is, the third tooth 42c) and closest to the point of rotation for the pawl 16. This reduces wear on the rest of the teeth 42a, 42b, increasing the longevity of the mechanism and decreasing the rotational friction. The third tooth 42c that rides on the gear ring 14 as it is in freewheel has geometry that allows for a decrease in rotating friction.

In addition to the provision of multiple teeth 42a-c on each pawl 16, the various pawls 16 mounted within the present gearing mechanism 10 are out of phase. As such, and in accordance with a preferred embodiment as shown in FIGS. 3, 4 and 5, six pawls 16 are provided. The six pawls 16 are divided into two groups of three pawls 16 and are alternated about the circumference of the gearing mechanism 10. As such, the first set of pawls 46 will engage, that is, seat within, the recess 36 of the gear ring 14 at a simultaneous point during rotation of the gear ring 14 relative to the inner rotor member 12. The other three pawls, that is, the second set of pawls, 48 are out of phase and do not seat within the recesses 36 when the first set of pawls 46 seat within the recesses 36. In accordance with a preferred embodiment, the preferred degrees to phase would be half of the degrees that the gearing mechanism 10 has within the gear ring 14, or the number of degrees that there are without the phasing. By placing the first set of pawls 46 out of phase with the second set of pawls 48, the time period during which one must wait before engagement of the pawls 16 with the gear ring 14 is effectively reduced, because one does not need to wait for the pawls 16 to move along a complete length of one recess 36 of the gear ring 14 before seating therein.

Although a preferred embodiment has been disclosed with pawls having three teeth each and two sets of out of phase pawls, the number of teeth and the number of pawl sets may be varied without departing from the spirit of the present invention.

The gear ring 14 has several unique features as well, the first being the recesses 36 are made with a geometry matched to that of the pawl teeth 42a-c and specifically designed to decrease rotating friction. In addition, the teeth 42a-c are formed with an angular orientation optimizing function and frictional engagement and this orientation may be varied to suit specific applications. More particularly, the orientation of the teeth 42a-c and recesses 36 allow for secure coupling when they are rotated in a first direction and substantially smooth passing when they are rotated in the opposite direction.

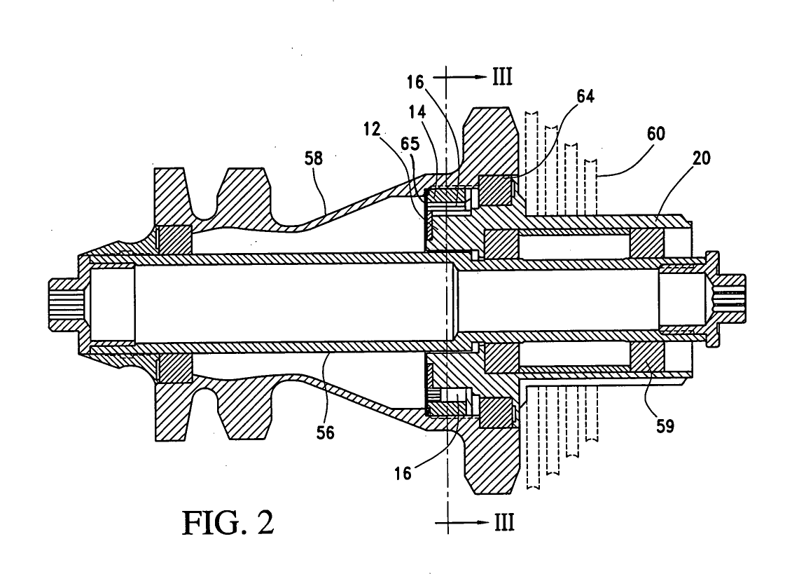

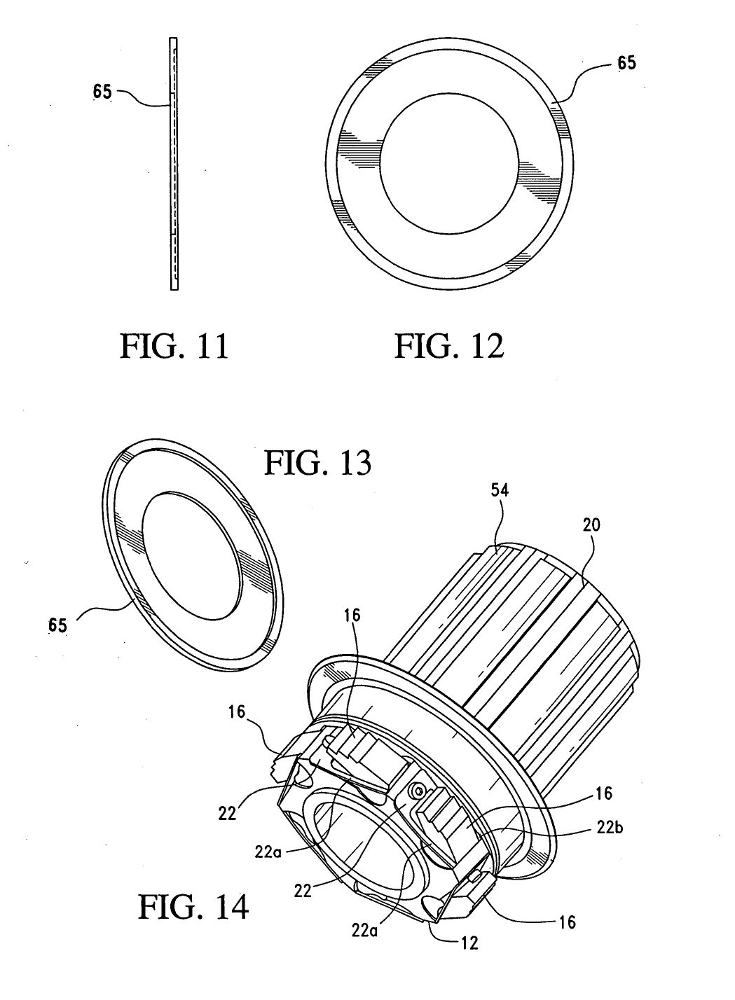

Second, the leading edge 50 of the gear ring 14 is angled in a manner facilitating the placement of the cassette body 20 and pawls 16 into the gear ring 14. There are also external threads 52 on the outside of the gear ring 14 for attachment to the wheel hub 58. However, and as those skilled in the art will appreciate, attachment may be achieved in various known ways, for example, via splines or other methods of attachment. A seal, or bearing, 64 is further provided between the gear ring 14 and the cassette body 20 to keep particles and debris from entering the gearing mechanism 10 from the side opposite the cassette body 20. A seal, or grease trap, 65 is also provided at the side opposite the seal 64 to keep debris from entering and grease from exiting the gearing mechanism 10 (see FIGS. 2, 11, 12 and 13).

By adding more teeth (one, two, three or more) to the pawls 16 in accordance with a preferred embodiment of the present invention, a number of things are accomplished. First, contact area is added from the pawl 16 to the gear ring 14, enabling a stronger connection. Second, by adding pawls 16 and phasing them to engage at certain angles, generally half the angle of the gear ring recesses 36, one set 46, 48 of pawls 16 engages the gear ring 14 at the fastest possible time. Through the use of these two techniques, the engagement time of the pawls 16 has been greatly reduced in accordance with the present invention.

An example of a standard pawl type mechanism with one set of pawls is that it engages approximately 15-20 degrees of rotation. In accordance with the present invention, three teeth are placed on one pawl and the present invention is thus able to increase the gear ring to 60 teeth and an engagement time of six degrees. Through further phasing of an additional set of pawls, the present invention has been able to decrease the time taken to engage the pawls by half and thus have a total engagement time of three degrees.

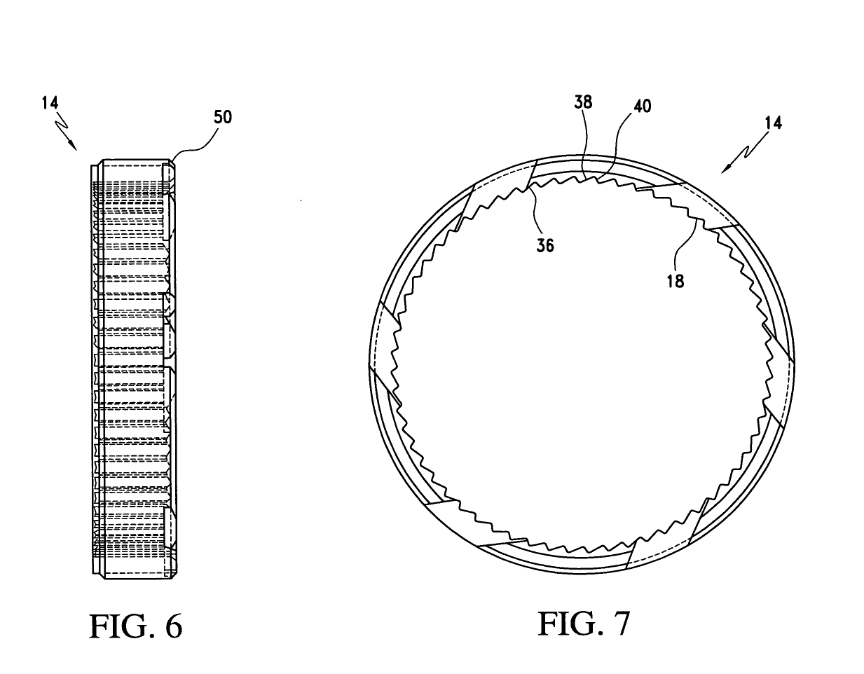

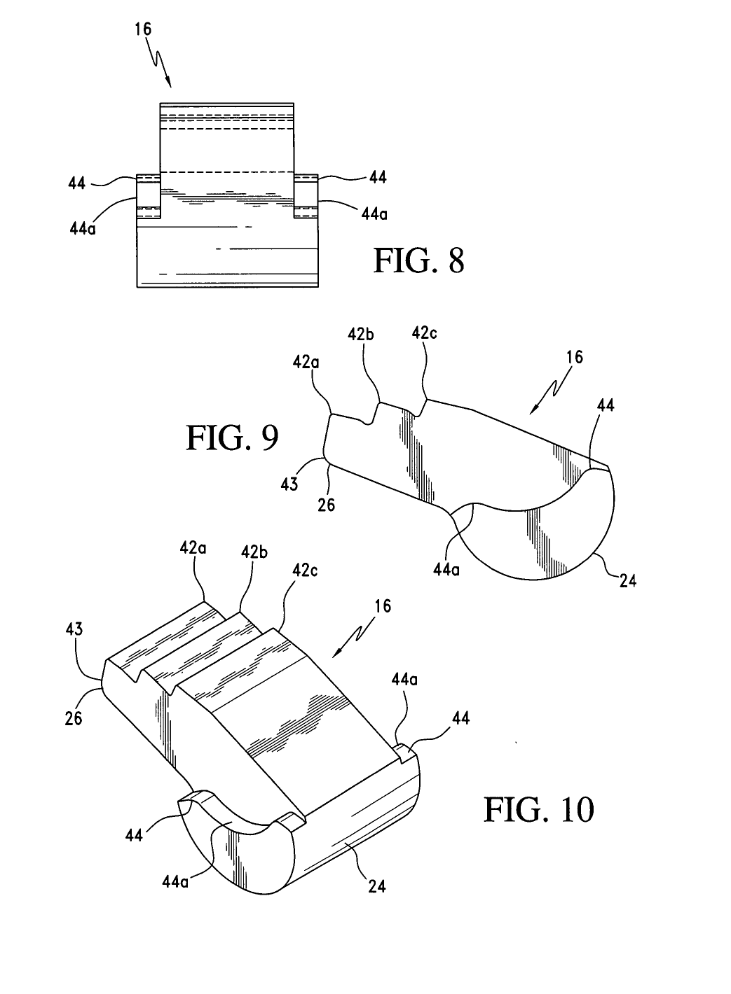

As discussed above, the relationship between the recesses 36 of the gear ring 14 and the teeth 42a-c of the pawls 16 is important to proper operation of the present gearing mechanism. With this in mind, preferred dimensions for the pawls 16 and gear ring 14 are shown in FIGS. 6, 7, 8 and 9 of commonly owned U.S. Provisional Patent Application Ser. No. 60/801,383, entitled “MULTI-TOOTH PAWL TYPE GEARING MECHANISM”, filed May 19, 2006, which is incorporated herein by reference. While preferred dimensions are disclosed in accordance with a preferred embodiment, those skilled in the art will appreciate that these dimensions may be varied without departing from the spirit of the present invention.

While the preferred embodiments have been shown and described, it will be understood that there is no intent to limit the invention by such disclosure, but rather, is intended to cover all modifications and alternate constructions falling within the spirit and scope of the invention.

1. A multi-tooth pawl type gearing mechanism for a freewheel of a bicycle wheel hub, comprising:
a cassette body including an inner rotor member having an axis;
a gear ring shaped and dimensioned for attachment to a wheel hub of a bicycle wheel allowing for the transferring of power from the gear ring to the bicycle wheel, the gear ring surrounding the inner rotor member and including an inner surface;
a series of pawls, wherein each pawl includes a first end and a second end, positioned between the inner rotor member and the gear ring for transmitting power therebetween in a unilateral direction as the inner rotor member is rotated;
wherein when the inner rotor member is rotated in a first direction the pawls are brought into engagement with the inner surface of the gear ring thereby transmitting rotation of the inner rotor member to the gear ring and when the inner rotor member is rotated in an opposite second direction the pawls slide over the inner surface of the gear ring and rotation of the inner rotor member is not transmitted to the gear ring.

2. The gearing mechanism according to claim 1, wherein the pawls are out of phase.

3. The gearing mechanism according to claim 2, wherein each pawl includes a series of teeth along the second end thereof, the teeth are shaped and dimensioned for positioning within recesses formed along the inner surface of the gear ring, the teeth are shaped and dimensioned to seat within the recesses and couple thereto when the inner rotor member is rotated in the first direction and slide over the recesses of the gear ring when the inner rotor member is rotated in the second direction.

4. The gearing mechanism according to claim 3, wherein the geometry of the teeth on the pawl is designed so that when in free rotation only a tooth furthest from a tip of the pawl and closest to a point of rotation for the pawl interacts with the gear ring to reduce wear on the rest of the teeth.

5. The gearing mechanism according to claim 2, wherein six pawls are provided.

6. The gearing mechanism according to claim 1, wherein a leading edge of the gear ring is angled in a manner facilitating placement of the cassette body and pawls into the gear ring.

7. The gearing mechanism according to claim 1, wherein a seal is further provided between the gear ring and the cassette body.

8. The gearing mechanism according to claim 1, wherein a spring is associated with each pawl, and the spring holds the pawl in place and biases respective pawls into the gear ring.

9. The gearing mechanism according to claim 8, wherein each pawl includes milled portions, the spring engaging an upper surface of the milled portions and acting to rotate the pawl and hold it down into a rotor member recess of the inner rotor member of the cassette body at a particular angle to facilitate ease of placement into recesses formed along the inner surface of the gear ring.

10. The gearing mechanism according to claim 9, wherein the milled portions on each pawl are shaped and dimensioned to maintain the pawl in a particular position and angle, and keep it from biasing too far toward the gear ring to facilitate an easier placement of the cassette body and pawls into the inner surface of the gear ring where the pawls are pushed down for assembly.

11. The gearing mechanism according to claim 10, wherein each spring respectively biases the pawl toward the gear ring

12. The gearing mechanism according to claim 11, wherein each spring is substantially U-shaped.

13. The gearing mechanism according to claim 12, wherein each spring includes opposed arms which engage opposite sides of the pawl for biasing it toward the gear ring and centering the pawl in the cassette body while the spring action holds the pawl in place.

14. The gearing mechanism according to claim 1, wherein the inner rotor member includes an outer surface having a series of rotor member recesses shaped and dimensioned for receiving the first end of respective pawls in a manner supporting the pawls for rotation relative thereto.

15. The gearing mechanism according to claim 14, wherein each of the rotor member recesses includes a semi-circular profile in which the first end of the respective pawl is seated for rotation relative thereto, each rotor member recess is shaped and dimensioned with a radius of curvature matching the radius of curvature formed along the first end of the pawl.

16. The gearing mechanism according to claim 15, wherein springs are positioned between each of the pawls and the inner rotor member in a manner which maintains the first end of the pawl within the rotor member recess and biases the second end of the pawl toward the gear ring.

17. The gearing mechanism according to claim 16, wherein the inner surface of the gear ring is formed with a series of recesses thereabout, the recesses are equally spaced and are shaped and dimensioned for receipt of the respective pawls, the recesses are shaped and dimensioned to engage the second end of the respective pawls when the inner rotor member is rotated in the first direction and permit the second end of the pawls to slide there across when the inner rotor member is rotated in an opposite, second direction.

18. The gearing mechanism according to claim 17, wherein each pawl includes a series of teeth along the second end thereof, the teeth are shaped and dimensioned for positioning within the recesses formed along the inner surface of the gear ring, the teeth are shaped and dimensioned to seat within the recesses and couple thereto when the inner rotor member is rotated in the first direction and slide over the recesses of the gear ring when the inner rotor member is rotated in a second direction.

19. The gearing mechanism according to claim 18, wherein the geometry of the teeth on the pawl is designed so that when in free rotation only a tooth furthest from a tip of the pawl and closest to a point of rotation for the pawl interacts with the gear ring to reduce wear on the rest of the teeth.

20. The gearing mechanism according to claim 19, wherein each recess includes an angularly oriented long first wall and a short second wall, the second wall being oriented such that teeth on the second end of the pawl seat within the recesses and abut the second wall in a manner preventing further rotation of the gear ring relative to the pawl when the inner rotor member is rotated in the first direction, and this configuration allows the teeth of the pawl to slide up and over the long first wall of each recess when the gear ring is rotated in the second direction opposite the first direction.
